(19) United States
(12) Patent Application Publication
(10) Pub. No.: US 2014/0211674 A1
(43) Pub. Date: Jul. 31, 2014

(54) ADVANTAGEOUS USES OF INSTRUCTIONS INSTRUCTING STATIONS OF WLAN NETWORKS TO DESIST FROM TRANSMISSIONS

(71) Applicant: GAINSPAN CORPORATION, San Jose, CA (US)

(72) Inventor: Indudharswamy G. Hiremath, Bangalore (IN)

(73) Assignee: GainSpan Corporation, San Jose, CA (US)

(21) Appl. No.: 13/754,922

(22) Filed: Jan. 31, 2013

(51) Int. Cl. H04W 76/04

(52) U.S. Cl. CPC H04W 76/04
USPC 370/311; 370/329

(57) ABSTRACT

A wireless device provided according to an aspect of the present invention first operates as an access point (AP) and transmits instructions which instruct associated stations to desist from transmitting data packets to the AP. According to another aspect, the instructions correspond to CTS-to-self signal, but the AP also desists from transmission of data packets in the desist duration. According to another aspect, the wireless device operates as a station in the desist duration and switches back as an AP after end of the desist duration. In an embodiment, the station scans for other APs/stations in the communication range, and associates with one of such APs also.

### BACKGROUND OF THE INVENTION

1. Technical Field

Embodiments of the present disclosure relate generally to wireless local area (WLAN) networks, and more specifically to additional advantageous uses of instructions instructing stations of WLAN networks to desist from transmissions.

2. Related Art

A wireless local area network (WLAN) generally refers to a network in which wireless devices communicate with each other over a wireless medium in conformity with standards such as IEEE 802.11 family of standards for short distance communications (as contrasted with GSM type protocols intended for long distance communications). As is well known, such WLAN based technologies rely on an access point (AP), which normally operates as a switching device to facilitate wireless stations to communicate with each other, and also potentially with devices external to a WLAN. On the other hand, wireless stations typically are either source (where data is created/formed for transmission by wireless network) or destination (the eventual machine to which the packet is delivered) of data.

IEEE 802.11 standards define instructions, which instruct stations to desist from transmissions for a duration usually specified in the corresponding instructions. One example of such an instruction is a CTS-to-self signal, which can be transmitted by a wireless device (AP or station) when the access point has data available for transmitting to a wireless station. The CTS-to-self signal operates as an instruction to other wireless devices to desist from transmitting for a duration specified by the access point in the CTS-to-self signal, thereby reserving the channel for the access point in that duration. Thus, the access point, in normal course of operation, transmits the available data to the corresponding wireless station following the CTS-to-self signal. The CTS-to-self signal thus provides a mechanism by which an access point can reserve a channel for a duration, and thereafter transmit data in the reserved duration.

Another example of such an instruction in accordance with 802.11 standards is based on a ‘quiet element’, provided as a field of a beacon. As is well known, beacons are transmitted by APs at regular intervals to indicate their presence to any stations within their respective communication ranges. The quiet elements in such beacons can be set to indicate when and how long the associated wireless stations are to desist from transmission of data packets to the AP. The APs are known to use such quiet periods for performing (or to allow performing of) any required tests/measurements of the channels.

Aspects of the present invention provide for other advantageous uses of instructions instructing stations of WLAN networks to desist from transmissions.

### BRIEF DESCRIPTION OF THE VIEWS OF DRAWINGS

Example embodiments of the present invention will be described with reference to the accompanying drawings briefly described below.

FIG. 1 is a block diagram a Wireless Local Area Network (WLAN) in which several features of the present invention can be implemented.

FIG. 2 is a flow chart illustrating the operation of an access point according to an aspect of the present invention.

FIG. 3 is a block diagram illustrating the details of a wireless device operating as both an access point and a wireless station in an embodiment.

FIG. 4 is a timing diagram illustrating the operation of a wireless device as both an access point and a wireless station in an embodiment.

FIG. 5 is a block diagram illustrating the details of an access point in an embodiment.

The drawing in which an element first appears is indicated by the leftmost digit(s) in the corresponding reference number.

### DETAILED DESCRIPTION

1. Overview

According to an aspect of the present invention, a wireless device transmits instructions which instruct stations of same or different BSS, to desist from transmitting data packets (or in general, any frames), and thereafter provides various utilities in the corresponding ‘desist’ duration as briefly described below.

According to another aspect of the present invention, the instructions correspond to a CTS-to-self signal, and the wireless device thereafter desists from transmissions for a duration specified in the CTS-to-self signal. Stations in receipt of the CTS-to-self signal also desist from transmission in such a duration (“desist duration”). In an embodiment, the wireless device operates in a power-saving mode in the desist duration.

According to yet another aspect, a wireless device operating as an AP, switches to operate as a station in the desist duration. The station can potentially associate with other APs in such desist duration and exchange data packets using such APs. The operation of the station is switched back as an AP after the end of such a duration.

According to one more aspect of the present invention, in the desist duration, the wireless device operating as a station scans for the presence of other APs and stations within the communication range. The station may associate itself with one of such discovered APs.

Several aspects of the invention are described below with reference to examples for illustration. It should be understood that numerous specific details, relationships, and methods are set forth to provide a full understanding of the invention. One skilled in the relevant arts, however, will readily recognize that the invention can be practiced without one or more of the specific details, or with other methods, etc. In other instances, well-known structures or operations are not shown in detail to avoid obscuring the features of the invention.

2. Example Environment

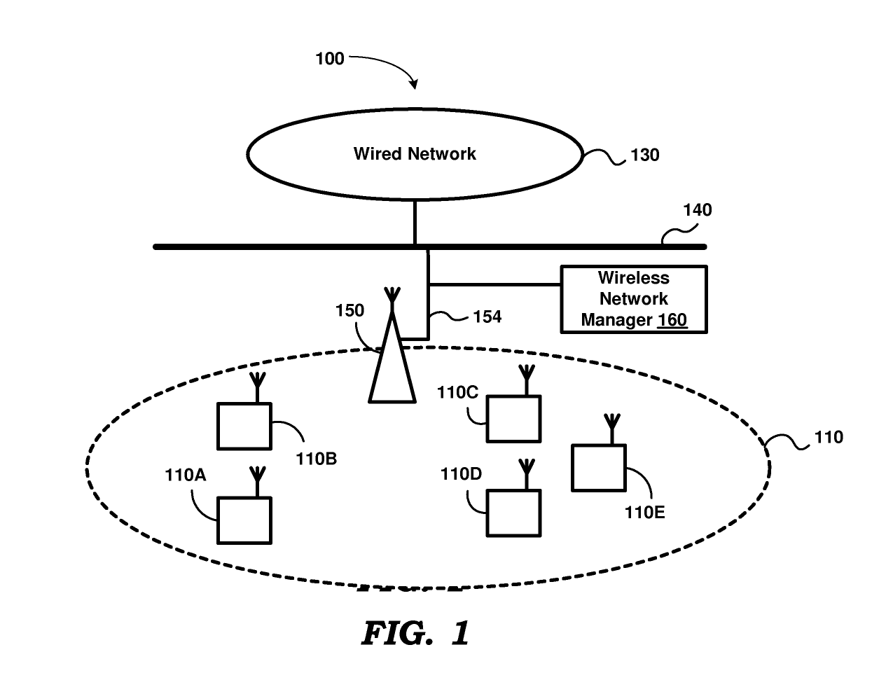

FIG. 1 is a block diagram illustrating an example environment in which several features of the present invention can be implemented. The example environment is shown containing only representative systems for illustration. However, real-world environments may contain many more systems/components as will be apparent to one skilled in the relevant arts. Further, in the description below, the components and the environment are described as operating consistent with IEEE 802.11 standard(s), merely for illustration. Implementations in other similar wireless environments are also contemplated to be within the scope and spirit of various aspects of the present invention.

System 100 is shown containing wireless stations (stations) 110A-110E, access point (AP) 150 (also referred to as wireless device in some embodiments described below), wired network 130, wired network backbone 140 and wireless network manager 160. Block 110 represents a basic service set (B SS) consistent with the 802.11 standard(s). In general, each BSS contains an AP and associated stations. Association (in the context of WLAN operation) generally refers to registration of a wireless station with an AP, thereby enabling the station to transmit/receive data packets to/from other stations in the WLAN or with devices external to the WLAN. Association entails transmission of an association request message by a wireless station to an AP, to which the AP may subsequently respond with an association response message (which may include an association identifier) to complete the association of the station to the AP.

In addition, as is well known, the APs and associated stations of a BSS communicate in a specific band, and devices of different BSS can overlap geographically if operating in different bands. Though not shown, system 100 may contain other BSS, with different operating bands.

AP 150 is connected by a wired medium (154) to wired network backbone 140, and thus to wired network 130. Each of stations 110A-110E may communicate with AP 150 (as well as with each other) wirelessly (over a wireless medium) according to any of the family of IEEE 802.11 protocols (including as specified in IEEE 802.11a, 802.11b, 802.11g and 802.11n), and thereby with wired network 130. Wired network 130 may represent the internet, also known as the World Wide Web. One or more of stations 110A-110E may correspond, for example, to a laptop computer, smart phone, or a wireless sensor.

Wireless network manager 160 may transmit configuration and control messages to AP 150. Some of the configuration and control messages may be meant for stations 110A-110E. Accordingly, AP 150 forwards the corresponding configuration and control messages meant for the stations, either as unicast messages (directed to a specific one of stations 110A-110E) or as broadcast messages. Although shown separate from AP 150, the features of wireless network manager may instead be integrated within AP 150 in some embodiments.

Wireless network manager 150 may additionally be designed to operate as a controller of BSS 110, and issue network commands to and receive data from one or more of stations 110A-110E, and may thus operate to provide desired features such as building or plant automation, based on the specific environment in which the components of FIG. 1 are deployed. The data received from stations 110A-110E may represent measured values of desired parameters such as temperature, pressure, humidity, etc. In other embodiments, stations 110A-110E may be deployed for purposes other than for providing features such as plant automation. For example, one or more of stations may represent a computing device such as a laptop, and may transfer data with other devices in BSS 110 or wired network 130 based on the requirements of the user of the laptop.

Wireless device/AP 150 provided according to several aspects of the present invention advantageously uses instructions instructing stations to desist from transmissions. In embodiments described below, such instructions are described to be either CTS-to-self signal or the quiet element in beacons in corresponding example embodiments.

Merely for convenience, the features with respect to CTS-to-self signal are described first. Wireless device 150 may transmit a CTS-to-self signal on the wireless medium when AP 150 has data available and to be sent to one of clients 110A-110E. A CTS-to-self signal operates as an instruction to wireless stations 110A-110E to desist from transmitting for a duration specified by the access point in the CTS-to-self signal, thereby reserving the channel for the transmission by AP 150. The duration specifies the time needed for completing the transmission of the data by AP 150. Subsequent to the transmission of the CTS-to-self signal, AP 150 transmits the data to the corresponding wireless station(s).

Thus, in the normal course (i.e., without error/exception/failure conditions including those on wireless device/stations, and situations such as excessive bandwidth usage, obstructions in the channel, etc., on the wireless medium) of operation of AP 150 (and the other components of FIG. 1), the issuance of a CTS-to-self signal by AP 150 is followed by data transmission by AP 150. The corresponding wireless station then receives the data and process the data.

Aspects of the present invention provide for other advantageous uses for the CTS-to-self signal in WLAN networks, as described below with examples.

3. Use of CTS-to-Self Signal

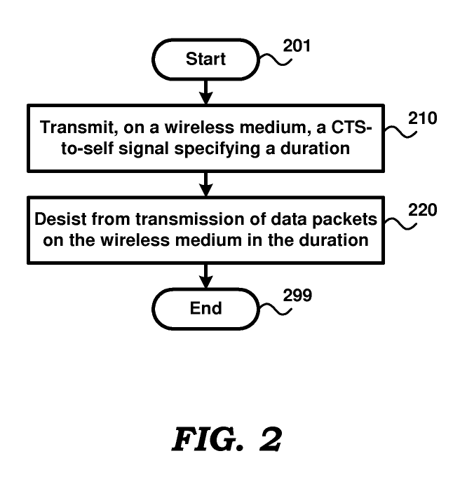

FIG. 2 is a flowchart illustrating the manner in which CTS-to-self signal is used in an embodiment of the present invention. The steps in the flowchart are described with respect to FIG. 1, and with specific reference to AP 150 merely for illustration. Alternative embodiments in other environments can also be implemented without departing from the scope and spirit of several aspects of the present invention, as will be apparent to one skilled in the relevant arts by reading the disclosure provided herein. The flowchart starts in step 201, in which control passes immediately to step 210.

In step 210, AP 150 transmits, on a wireless medium, a CTS-to-self signal specifying a duration. CTS-to-self signal represents an example signal for an access point to reserve a channel and thereafter transmit a data packet in the reserved duration in normal course of operation.

In step 220, access point 150 desists from transmission of data packets on the wireless medium in the duration. Desisting implies that the access point does not transmit data packets in that duration. Such desisting is performed in the normal course of operation of AP 150, implying there is no data transmission by access point 150 even if the channel is free for transmission and the operation of stations/access point is otherwise normal. In sharp contrast, as described above, access points transmit CTS-to-self signals to reserve the channel for transmission of data packets, and in normal course transmit data packets after transmission of CTS-to-self signal. The flow chart ends in step 299.

It should be appreciated that such desisting may be performed for any of a number of specific purposes, while the access point transmits data packets following the sending of CTS-to-self signal in other durations, in normal course. Furthermore, the flow chart of FIG. 2 can be performed by stations (in general, wireless devices) as well, though the description is provided with respect to AP. The description is continued with respect to operation for some example specific purposes.

4. Wireless Device Operating as Both an Access Point and a Wireless Station

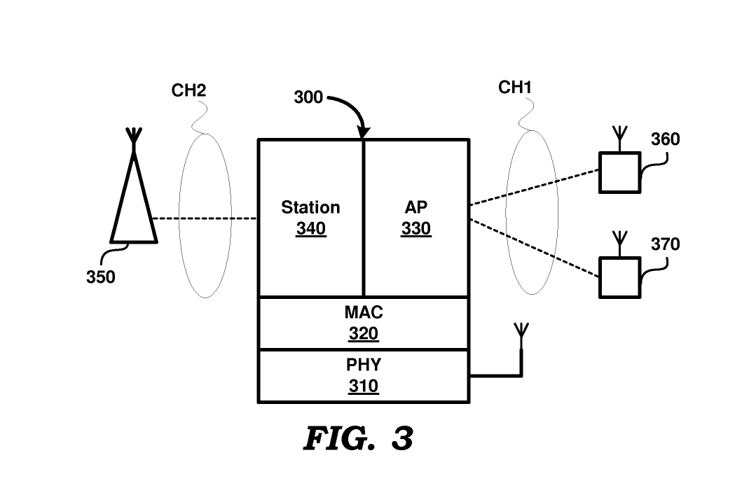

FIG. 3 is a block diagram illustrating the details of a wireless device designed to operate both as an access point and as a wireless station, in an embodiment. The operation as an access point corresponds to access point 150 of FIGS. 1/2. Wireless device 300 of FIG. 3 is shown containing physical layer (PHY) 310, medium access control (MAC) layer 320, station functionality 340 and AP functionality 330. Also shown in the Figure are AP 350, and wireless stations 360 and 370.

PHY 310 represents the physical layer (hardware) required to enable operation as a wireless device and may be implemented according to the IEEE 802.11 specifications. MAC 320 represents the data link layer of wireless device 300, and may be implemented according to the IEEE 802.11 specifications.

Blocks 330 and 340 respectively represent corresponding executable (software) modules that are designed to enable wireless device 300 to operate respectively as an AP and as a station. It is noted here that when configured to operate as AP 330, wireless device operates in place of AP 150 of FIG. 1, with stations 360 and 370 operating as stations of BSS 110.

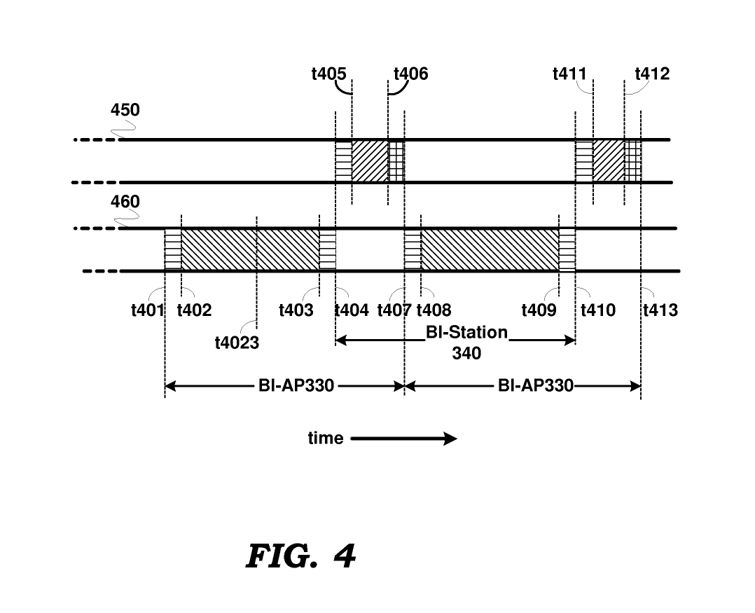

The operation of wireless device 300 as AP 330 and station 340 is performed in a time division multiplexed (TDM) manner, as illustrated with respect to the timing diagram of FIG. 4. For ease of description, wireless device 300 is referred to herein as AP 330 when operating as an AP, and as station 340 when operating as a wireless station. Waveform 450 illustrates the time intervals in which wireless device 300 operates as station 340, while waveform 460 illustrates the time intervals in which wireless device 300 operates as AP 330.

When operating as station 340, wireless device 300 operates (transmits and receives) in a frequency band or channel (indicated as CH2 in FIG. 3) which is different from the frequency band/channel (indicated as CH1 in FIG. 3) in which wireless device 300 operates as AP 330.

With respect to FIG. 4, wireless device 300 starts operation as AP 330 at t401. In interval t401-t402, AP 330 transmits a beacon. Associated stations (370 and 380) may receive the beacon and respond accordingly. In interval t402-t403, AP 330 may exchange data packets with associated stations such as stations 360 and 370. At time instant t403, AP 330 transmits a CTS-to-self signal, thus notifying associated stations 360 and 370 to desist from transmitting any data packets for a duration (t404 to t407) specified in the CTS-to-self signal. Time instant t404 is assumed to represent the end of the CTS-to-self signal. According to the IEEE 802.11 standards, the duration is specified in a 16-bit duration field in the 802.11 MAC header. At t404, wireless device 300 switches to operation as station 340.

In interval t404-t405, station 340 receives a beacon from an AP with which station 340 is associated (shown as AP 350 in FIG. 3). Station 340 may exchange packets with AP 350 in time interval t405-t406. In interval t406-t407, station 340 transmits a NULL frame. The NULL frame contains an empty frame body, and a power management (PM) bit, with the PM bit set to one, thereby indicating to AP 350 that station 340 is going to ‘sleep’ (low-power/power-save) mode. At t407, wireless device 300 switches to operation as AP 330.

The time division multiplexed operation alternately as AP 330 and station 340 may be repeated. FIG. 4 shows one more such cycle, with wireless device 300 (operating as AP 330) again transmitting a beacon in the interval t407-t408, exchanging data packets with associated stations in interval t408-t409, and then sending a CTS-to-self signal again in interval t409-t410. The CTS-to-self signal in interval t409-t410 specifies a desist duration equal to time interval t410-t413. At t410, wireless device 300 commences operation as station 340 once again, and receives a beacon from AP 350 in interval t410-t411. In interval t411-t412, station 340 may exchange data packets with AP 350, and then transmit a NULL frame in interval t412-t413. At t413, wireless device 300 commences operation again as AP 330.

It may be noted that intervals t401-t407 and t407-t413 each represent one beacon interval (BI-AP330) corresponding to AP 330. Interval t404-t410 represents one beacon interval (BI-Station340) corresponding to station 340. It may be observed that the start instants of BI-AP330 and BI-Station 340 are staggered (or offset from each other), thereby permitting TDM operation as AP 330 and Station 340.

It may be further appreciated that AP 330 may transmit CTS-to-self signal, followed by corresponding data packets, as in normal course of operation, in intervals t402-t403, t408-t409, etc., prior to sending the CTS-to-self signal of step 210.

The specific considerations based on which the durations (and start/stop instants) of operations as AP 330 and station 340 are determined may include one or more of the following:

a) Station 340 may need to wake up every DTIM (or listen) interval to receive corresponding beacons from AP 350.

b) Station 340 may be required to stay active after a beacon from AP 350 (to receive multicast/broadcast data from AP 350 if the MCAST/BCAST bit in the beacon is set.

c) Station 340 may need to transmit to AP 350 a PS-poll frame or UAPSD (Unscheduled Automatic Power Save Delivery) trigger frame to receive unicast data from AP 350.

d) Station 340 may need to wake up for scheduled events such as SAPSD (Schedule Automatic Power Save Delivery) service period or SPSMP (Schedule Power Save Multi Poll).

e) Station 340 may need to wake up for sending NULL frame for Association Keepalive.

f) AP 330 may need to transmit a beacon at every TBTT.

g) AP 330 may need to transmit buffered broadcast/multicast data to stations (360/370) as specified by the DTIM.

h) AP 330 may need to transmit buffered unicast data to power-save stations upon receiving PS-poll or UAPSD trigger.

i) AP 330 may need to wake up for scheduled SAPSD service periods and SPSMP service periods.

Thus, as an illustration, duration t401-404 is designed to be short enough to end such that wireless device 300 switches to operate as station 340, in time to receive beacons from corresponding AP 350. Similarly, duration t404-t407 is designed to be short enough to end such that wireless device 300 switches to operate as AP 330, in time to transmit corresponding beacons to associated stations 360/370

In an embodiment, the TBTT (Target Beacon Transmission Times) of AP 330 are designed to occur after 20% to 25% of the beacon interval of station 340 has elapsed. To clarify, TBTT at t407 of AP 330 is designed to occur after the elapse of 20% to 25% of interval t404-t410(BI-Station340). As a result, AP 330 is enabled to be active for 75% to 80% of the beacon interval (BI-AP330) of AP 330. However, in other embodiments, other values for the occurrences of the TBTTs of AP 330 with respect to a beacon interval of station 340 may be used. Furthermore, the durations of operation as station 340 and AP 330 may be dynamically changed, based for example on the volume of data that may need to be transmitted/received by either AP 330 or station 340.

While in FIG. 4, station 340 is shown as “waking up” (or resuming operation) at the start of every beacon transmission of AP 350, in other embodiments, station 340 may be designed to wake up only once every multiple occurrences of beacon transmission of AP 350. In particular, wireless device 300 may operate as station 340 only once every DTIM (delivery traffic indication message) interval of AP 350. In such embodiments, wireless device 300 switches to operate as station 340 only after several beacon intervals (BI-AP330) of AP 330.

Further, while it is noted above that wireless device 300 switches to operation as station 340 immediately after the end of a corresponding CTS-to-self signal, in other embodiments, there may be a lapse of a time interval between the end of a CTS-to-self signal and the corresponding commencement of operation as station 340, with appropriate design of the instruction content and/or other pre-specified conventions.

It is noted that the respective modules (or collection of modules) representing AP 330 and station 340 may be scheduled for operation as corresponding multi-tasking threads or processes, with the contexts of each thread/process being saved at the time of exit from the corresponding thread/process. The context may then be restored prior to resuming operation of the corresponding thread/process.

The saved context thus needs to include all state information (including hardware register entries in MAC 320), which permits the wireless device to resume operation as AP 330 and station 340, during respective phases of the iterations/cycles. In case of station 340 (i.e., before transitioning to operation as AP 330), the saved information includes TSF (Timing Synchronization Function) counter, beacon interval, BSSID (Basic Service Set Identifier), DTIM (Delivery Traffic Indication Message), listen interval, security keys, etc., which are set prior to switching to operation as AP 330. In case of AP 330 (before transitioning to operation as station 340), the saved context/information similarly includes the list of associated stations, TSF counter, BSSID, beacon interval, DTIM, MAC addresses, security keys and listen intervals of the respective associated stations, whether any of the stations are operating in power save mode (in general, all information previously negotiated with associated stations), etc.

Based on the specific implementation of MAC 320 and PHY 310, the respective processes/threads may need to configure PHY 310 (for example, for selecting the channel/frequency band of operation), and corresponding registers in MAC 320 for effecting operation as AP 330 and station 340.

The description is continued with respect to other example uses of CTS-to-self signal in a WLAN.

5. Enabling Power-Save in an AP

According to another aspect of the present disclosure, CTS-to-self signals are used to enable an AP to enter power-save (or low-power) states. In an embodiment, an AP (e.g., AP 150 of FIG. 1 or AP 330 of FIG. 3) transmits a CTS-to-self signal prior to entering a low-power state, making the wireless device inoperative as both AP and station.

Thus, with respect to FIG. 4 (and ignoring waveform 450), the AP is active (fully operational) in interval t401-t404. At t404, the AP enters a low-power state, and remains in the low-power state till t407. In low-power state, at least some of the circuits (typically the ones that consume substantial power, e.g., the receive and transmit chains) are switched off (no power consumed), thereby reducing power consumption (compared to the normal mode of operation in non-desist durations).

The AP resumes full operation again at t407, and enters the low-power state again at t410. During the low-power durations, stations associated with the AP (e.g., stations 110A-110E in the case of AP 150, and stations 360 and 370 in the case of AP 330) refrain from transmitting any data packets (or in general, any frame) as required by the corresponding CTS-to-self signal, thereby ensuring that there is no loss of packets due to non-availability (low-power state) of the AP.

6. Scanning for Networks

According to another aspect of the present disclosure, CTS-to-self signals are used to enable wireless device 300 to scan for and discover APs and stations within communication range of wireless device 300. Initially, wireless device 300 operates as AP 330 and receives from a user (via corresponding inputs) an instruction to scan the wireless medium for other APs and/or stations (other WLAN networks in general).

In response to the user instruction, AP 330 transmits a CTS-to-self signal, thereby signaling stations 360 and 370 not to transmit data packets to AP 330 for a corresponding duration. The transmission of the CTS-to-self signal may be appropriately delayed to allow AP 330 to complete a current operation as an AP.

Thus, with respect to FIG. 4, AP 330 may receive the user instruction at a time instant t4023, but defers transmission of a CTS-to-self signal till t403, while continuing operations normally as AP 330 till t403. At the end of the CTS-to-self signal at t404, wireless device 300 switches to operation as station 340.

Station 340 then scans one or more channels of the wireless medium to discover the presence of APs and other wireless stations. Scanning implies ‘listening’ to signals, such as beacons, in the various frequency bands/channels (allotted for WLAN operation, and such as channels CH1 and CH2 of FIG. 3) of the wireless medium. Scanning may also imply transmission of a ‘probe request’ message by station 340, to which an AP may respond with a ‘probe response’ message. The scanning may continue till end of the desist duration at t407, at which wireless device 300 switches to operating as AP 330. A next cycle of operation as station 340 to scan for APs/stations may commence once again at t410. Alternatively, if further operation as AP 330 is not desired (such being configurable in wireless device 300), wireless device 300 may continue operation as station 340 after transmission of the first CTS-to-self signal.

The results of scanning may provide station 340 with a list of APs (including AP 350 of FIG. 3) and stations in the vicinity i.e., within communication range of station 340. Station 340 may display (or otherwise provide) the list of APs and/or stations thus discovered to the user. The user may then indicate to station 340 the specific one (e.g., AP 350 of FIG. 3) of the discovered APs/stations with which to exchange data packets.

Another example of an instruction instructing stations of WLAN networks to desist from transmissions is a “quiet element” that can be transmitted in a beacon by an AP. Advantageous uses of such a quiet element are described below with examples.

7. Quiet Element in a Beacon

In accordance with the IEEE 802.11 standards, an AP can transmit a quiet element in a beacon to instruct associated stations to desist from transmitting data packets to it (the AP). The quiet element constitutes a set of bytes in the beacon, and specifies both the start of and the length of a “quiet” period, in which the AP may not be available (functionally) to receive packets from associated stations.

According to aspects of the present invention, the quiet element is transmitted in lieu of CTS-to-self signal and the various features described above with respect to FIGS. 3 and 4 are obtained, as described below briefly.

With respect to FIG. 4, wireless device 300 operating as AP 330 transmits a quiet element in the beacon of interval t401-t402. The quiet element can be constructed to indicate one or more corresponding quiet periods such as, for example, intervals/periods t404-t407 and t410-t413. Consequently, stations associated with the AP 330 desist from transmission in the quiet periods. In durations between the quiet periods, wireless device 300 may operate as AP 330, while in the quiet periods wireless device can provide other utilities such as for example, operation as station 340, scanning for other APs and stations, powering down to a low-power state, etc., as described in detail above.

Thus, it is readily observed that a quiet element can be used as an alternative to a CTS-to-self (in which case the CTS-to-self signals noted above in intervals t403-t404 and t409-t410 of FIG. 4 may be absent), or may be used in conjunction with CTS-to-self signals. When used in conjunction, some of the desist durations may be specified by way of CTS-to-self signals, while others may be specified by way of quiet elements.

The features described above may be realized in various implementations. The details of a wireless device 300, in an embodiment, are described next.

8. Wireless Device

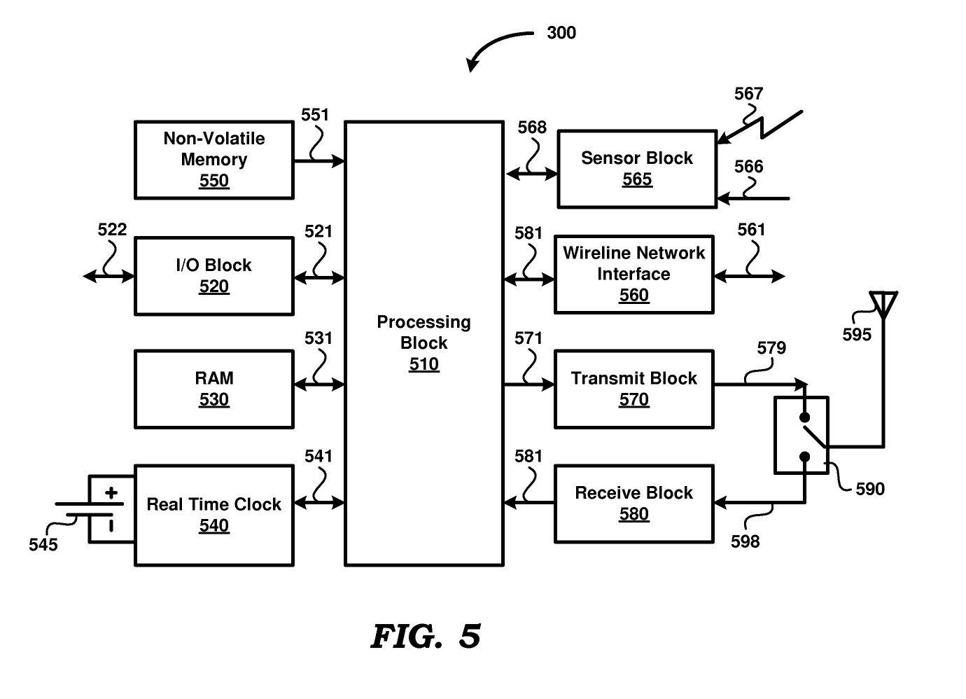

FIG. 5 is a block diagram of the internal details of wireless device 300 in an embodiment. Wireless device 300 is shown containing processing block 510, input/output (I/O) block 520, random access memory (RAM) 530, real-time clock (RTC) 540, battery 545, non-volatile memory 550, sensor block 565, wireline network interface 560, transmit block 570, receive block 580, switch 590 and antenna 595. The whole of wireless device 300 may be implemented as a system-on-chip (SoC), except for battery 545. Alternatively, the blocks of FIG. 5 may be implemented on separate integrated circuits (IC).

The components/blocks of wireless device 300 are shown merely by way of illustration, and wireless device 300 can also contain more or fewer components/blocks than shown. Further, although not shown in FIG. 5, all blocks of wireless device 300 may be connected automatically to an auxiliary power source (such as battery 545) in the event of failure of main power source (not shown).

Sensor block 565 may contain one or more sensors, as well as corresponding signal conditioning circuitry, and provides on path 568 measurements/values of physical quantities such as temperature, pressure, etc., sensed via wired path 566 or wireless path 567. Sensor block 565 enables wireless device 300 to collect sensor measurements when operating as station 340.

Antenna 595 operates to receive from and transmit to a wireless medium, corresponding wireless signals containing data. Switch 590 may be controlled by processing block 510 (connection not shown) to connect antenna 595 either to receive block 580 via path 598, or to transmit block 570 via path 579, depending on whether wireless device 300 is to receive or transmit.

Transmit block 570 receives data to be transmitted on path 571 from processing block 510, generates a modulated radio frequency (RF) signal according to IEEE 802.11 standards, and transmits the RF signal via switch 590 and antenna 595. Receive block 580 receives an RF signal bearing data via switch 590 and antenna 595, demodulates the RF signal, and provides the extracted data to processing block 510 on path 581. Transmit block 570 and receive block 580, in conjunction with processing block 510, together constitute PHY 310 of wireless device 300. Although not shown in FIG. 5, transmit block 570 and receive block 580 may be configured via corresponding controls (also not shown) to enable selection (for example, by processing block 510) of the specific frequency band/channel in which transmission/reception is to be done.

Wireline network interface 560 enables connection of wireless device 300 to a wired backbone such as backbone 140 (FIG. 1), and may be implemented according to one of several well-known wireline network technologies. Wireline network interface 560 may be used by wireless device 300 when operating as AP 330.

I/O block 520 enables a user to provide inputs (e.g., configuration data) to wireless device, as well as to receive outputs from wireless device (e.g., list of discovered APs/stations). The inputs and outputs may be received/provided via paths 522 and 521.

RTC 540 operates as a clock, and provides the ‘current’ time to processing block 510 on path 541. RTC 540 may be backed-up by battery 545 (in addition to the normal source of power, not shown in the Figure). RTC 540 contains timers internally, that may be used by a multi-tasking manager module to schedule threads/processes for performing the operations of station 340 and AP 330. RTC 540 may also contain memory to store information received from processing block 510. Although not shown as such in FIG. 5, battery 545 may also be used as back-up power to one or more of the other components/blocks of wireless device 300.

Non-volatile memory 550 is a non-transitory machine readable medium, and stores instructions, which when executed by processing block 510, cause wireless device 300 to provide several desired features described in detail above. The instructions for performing the operations of AP 330 and station 340, as well as multi-tasking (or any other suitable technique) manager for switching between station 340 and AP 330 in a TDM manner, are stored in non-volatile memory 550.

Processing block 510 (or processor in general) may contain multiple processing units internally, with each processing unit potentially being designed for a specific task. Alternatively, processing block 510 may contain only a single general-purpose processing unit.

RAM 530 and non-volatile memory 550 (which may be implemented in the form of read-only memory/ROM/flash) constitute computer program products or machine (or computer) readable medium, which are means for providing instructions to processing block 510. Thus, such medium can be in the form of removable (floppy, CDs, tape, etc.) or non-removable (hard drive, etc.) medium. Processing block 510 may retrieve the instructions (via corresponding paths 551 and 531), and execute the instructions to provide several features of the present invention, as described above. In particular, the instructions executed by processing block 510 enable wireless device 300 to perform the operations of the flowchart of FIG. 2.

9. Conclusion

References throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

While various embodiments of the present invention have been described above, it should be understood that they have been presented by way of example only, and not limitation. Thus, the breadth and scope of the present invention should not be limited by any of the above-described embodiments, but should be defined only in accordance with the following claims and their equivalents.

What is claimed is:

1. A method of operating a wireless device, said method comprising:
transmitting, on a wireless medium, a CTS-to-self signal specifying a duration, said CTS-to-self signal being sent at a first time instance; and
desisting from further transmissions on said wireless medium for said duration after said first time instance upon said transmitting of said CTS-to-self signal.

2. The method of claim 1, wherein said desisting is performed in a normal course of operation as a first access point (AP) by said wireless device.

3. The method of claim 2, wherein, subsequent to said transmitting, said wireless device switches to operation as a wireless station,
said wireless device operating as said wireless station in said duration,
said wireless device resuming operation as said first AP after said duration, said wireless device switching back to operation as said wireless station after another duration,
wherein said another duration is designed to be short enough to end such that said wireless station is ready to receive beacons from a second AP,
wherein said duration is designed to be short enough to end such that said first AP is ready to transmit beacons to associated stations.

4. The method of claim 3, wherein said wireless station exchanges data packets with a second AP with which said wireless station is associated, wherein the frequency band of operation of said wireless station is different from the frequency band of operation of said first AP,
wherein target beacon transmission times (TBTT) of said first AP are designed to occur after a first percentage of a beacon interval of said wireless station has elapsed.

5. The method of claim 4, wherein said wireless station discovers one or more APs including said second AP prior to association.

6. The method of claim 5, wherein said wireless station:
provides as output a list of discovered APs including said second AP to a user;
receives a user selection indicating said second AP as the one with which to associate; and
associates with said second AP in response to said user selection.

7. The method of claim 2, wherein said AP:
switches to a low-power mode after said transmitting;
remains in said low-power mode in said duration, making said wireless device inoperative as said AP in said duration; and
resumes operation as said AP after said duration.

8. A non-transitory machine readable medium storing one or more sequences of instructions for causing an access point (AP) to communicate with stations in a Wireless Local Area Network (WLAN), wherein execution of said one or more sequences of instructions by one or more processors contained in said AP causes said access point to perform the actions of:
transmitting a first signaling message of a first type, wherein messages of said first type are designed to reserve a channel on said WLAN for a duration specified in the corresponding message, wherein said first signaling message specifies a first duration to reserve said channel for said first duration following transmission of said first signaling message;
sending a first data packet in said duration on said channel reserved for said duration;
transmitting a second signaling message of said first type specifying a second duration to reserve said channel on said WLAN for said second duration; and
desisting from transmitting data packets in said second duration in normal course.

9. The non-transitory machine readable medium of claim 8, wherein said first type is a CTS-to-self signal.

10. The non-transitory machine readable medium of claim 8, wherein said first type is a quiet element in a beacon transmitted by said AP.

11. The non-transitory machine readable medium of claim 9, wherein, subsequent to said transmitting said second signaling message, said AP switches to operation as a wireless station in said second duration,
said wireless station switching operation as said AP after said second duration,
said wireless device switching back to operation as said wireless station after a third duration,
wherein said third duration is designed to be short enough to end such that said wireless station is ready to receive beacons from a second AP,
wherein said second duration is designed to be short enough to end such that said AP is ready to transmit beacons to associated stations.

12. The non-transitory machine readable medium of claim 11, wherein said wireless station exchanges data packets with a second AP with which said wireless station is associated, wherein the frequency band of operation of said wireless station is different from the frequency band of operation of said AP.

13. The non-transitory machine readable medium of claim 12, wherein said wireless station discovers one or more APs including said second AP prior to association.

14. The non-transitory machine readable medium of claim 13, wherein said wireless station:
provides as output a list of discovered APs including said second AP to a user;
receives a user selection indicating said second AP as the one with which to associate; and
associates with said second AP in response to said user selection.

15. The non-transitory machine readable medium of claim 9, wherein said AP:
switches to a low-power mode after transmitting said second signaling message;
remains in said low-power mode in said duration, making said wireless device inoperative as said AP in said second duration; and
resumes operation as said AP after said second duration.

16. A method of operating a wireless device in a Wireless Local Area Network (WLAN), said method comprising:
operating said wireless device as an access point (AP);
transmitting, by said AP on a wireless medium at a time instance, an instruction instructing wireless stations of said WLAN to desist from transmitting for a duration;
operating said wireless device as a station in said duration after said time instance.

17. The method of claim 16, further comprising:
switching the operation of said wireless device back to said AP after the end of said duration.

18. The method of claim 17, further comprising scanning, in said duration, for the presence of other APs and stations in communication range with said wireless device operating as said station.

19. The method of claim 18, further comprising associating with a second AP discovered by said scanning.

20. The method of claim 16, wherein said instruction is one of a CTS-to-self signal and a quiet element of a beacon.
